(19) United States
(12) Patent Application Publication
(10) Pub. No.: US 2017/0179675 A1
(43) Pub. Date: Jun. 22, 2017

(54) Homogeneous Laser Light Source for Area Processing Applications

(71) Applicant: Newport Corporation, Irvine, CA (US)

(72) Inventors: James Burton Clark, Campbell, CA (US); David E. Spence, San Jose, CA (US); James David Kafka, Palo Alto, CA (US); Curtis L. Rettig, Livermore, CA (US); Bor-Chyuan Hwang, Los Altos, CA (US); Michael Scott Heuser, Mission Viejo, CA (US)

(73) Assignee: Newport Corporation, Irvine, CA (US)

(21) Appl. No.: 15/353,770

(22) Filed: Nov. 17, 2016

Related U.S. Application Data
(60) Provisional application No. 62/256,611, filed on Nov. 17, 2015.

(51) Int. Cl. H01S 3/109; H01S 3/16; H01S 3/00; H01S 3/10; G02F 1/35; G02B 27/09; H01S 3/067; H01S 3/0915

(52) U.S. Cl. CPC H01S 3/109; H01S 3/06754; H01S 3/1618; H01S 3/0915; H01S 3/10007; H01S 3/1611; H01S 3/1643; H01S 3/1638; H01S 3/1631; H01S 3/163; G02F 1/353; G02B 27/0927; H01S 3/0071; H01S 2301/02; G02F 2001/354

(57) ABSTRACT

The present application is directed to a homogeneous laser light source and includes at least one modeless seed source configured to output at least one modeless seed signal, at least one amplifier in communication with and configured to receive the modeless seed signal from the seed source and output at least one modeless amplifier signal, and at least one nonlinear optical generator configured to receive the amplifier signal and generate at least one modeless harmonic output signal in response to the modeless amplifier signal, wherein the wavelength of the harmonic output signal is different than a wavelength of the modeless amplifier signal.

### CROSS-REFERENCE TO RELATED APPLICATIONS

The present application claims priority to United States Provisional Pat. Appl. No. 62/256,611, entitled “Homogeneous Laser Light Source for Area Processing Applications,” filed on Nov. 17, 2015, and United States Provisional Pat. Appl. No. 62/308,863, entitled “Homogeneous Laser Light Source for Area Processing Applications,” filed on Mar. 16, 2016, the contents both of which are incorporated by reference in their entirety herein.

### BACKGROUND

Laser devices and systems are used in an ever increasing number of applications. For example, laser systems and devices are commonly used in numerous area processing applications. Typically, these area processing applications include laser systems and devices whose gain medium intrinsically produces a substantially uniform beam pattern. Exemplary applications for these laser systems and devices include photolithography, annealing of large area polycrystalline silicon, laser lift-off for display manufacturing, and other surface processing applications yet to be developed. Generally, economical manufacturing is best achieved by processing large areas, so a highly uniform beam is required at very high average power.

Presently, there are a number of laser systems used in area processing applications. For example, excimer lasers possess a very high gain and large uniform gain cross-section, allowing them to achieve very smooth output profiles with very few round trips within the laser cavity. However, a number of shortcomings associated with the use of excimer laser systems in area processing applications, and particularly in connection with photolithography and annealing applications, have been identified. For example, excimer lasers utilize consumable materials including hazardous gases. In addition, excimer laser systems tend to have a somewhat limited lifetime and high cost of operation when compared with other available laser systems.

In light of the foregoing, solid-state laser systems have been used previously in some area processing applications. These solid state laser systems possess very low cost of operation and low capital investment and, thus, may be favorable as an industrial tool. However, achieving beam uniformity to the degree required by area processing applications has been difficult, if not impossible with solid-state laser light sources at the power and pulse energies required without the use of additional and often complex and expensive beam homogenizing systems.

Thus, in light of the foregoing, there is an ongoing need for a homogenous laser light system capable of providing a high power, high brightness light source, lacking the spatial modulations characteristic of spatially and temporally coherent sources.

### SUMMARY

The present application is directed to various embodiments of a laser light source for use in area processing applications. In one embodiment, the present application is directed to a homogeneous laser light source and includes at least one modeless seed source configured to output at least one modeless seed signal. At least one amplifier is in communication with and configured to receive the modeless seed signal from the seed source and output at least one modeless amplifier signal. The amplifier signal is directed to at least one nonlinear optical generator configured to generate at least one modeless harmonic output signal in response to the modeless amplifier signal. The wavelength of the harmonic output signal is different than a wavelength of the modeless amplifier signal.

In another embodiment, the present application is directed to an optical system for use with a homogeneous laser light system. The optical system includes at least one beam director in optical communication with at least one nonlinear optical generator of the homogenous laser light source. Multiple Powell lenses may be positioned adjacently to and in optical communication with the beam director. Each Powell lens may be configured to act as an individual laser line generator device wherein at least a portion of each laser line output signal output by each Powell lens overlaps and/or is super-imposed on an adjacent laser line output signal output by an adjacent Powell lens to redistribute a substantially Gaussian intensity profile of the harmonic output signal from the nonlinear optical generator incident on the multiple Powell lenses to produce at least one laser line output signal having a substantially uniform intensity in one direction.

Lastly, the present application further discloses a broadband laser light source which includes at least one broadband seed source configured to output at least one broadband seed signal. At least one amplifier may be in communication with and configured to receive the broadband seed signal and output at least one broadband amplifier signal. At least one nonlinear optical generator in communication with the at least one amplifier, the at least one nonlinear generator configured to generate at least one broadband output signal in response to the broadband amplifier signal, wherein the wavelength of the broadband output signal is different than the wavelength of the broadband amplifier signal.

Other features and advantages of the various embodiments of the homogeneous laser light source for area processing applications as described herein will become more apparent from a consideration of the following detailed description.

### BRIEF DESCRIPTION OF THE DRAWINGS

Various embodiments of the homogeneous laser light source for area processing applications will be explained in more detail by way of the accompanying drawings, wherein:

FIG. 1 shows a block diagram of an embodiment of a homogeneous laser light source for use in area processing applications;

FIG. 2 shows a block diagram of another embodiment of a homogeneous laser light source having multiple seed sources therein for use in area processing applications;

FIG. 3 shows a block diagram of another embodiment of a homogeneous laser light source having multiple preamplifiers therein for use in area processing applications;

FIG. 4 shows a block diagram of another embodiment of a homogeneous laser light source having multiple amplifiers therein for use in area processing applications;

FIG. 5 shows a block diagram of another embodiment of a homogeneous laser light source having multiple nonlinear optical generators therein for use in area processing applications;

FIG. 6 shows a schematic diagram of the various components of used to construct an embodiment of a homogeneous laser light source for use in area processing applications;

FIG. 7 shows a schematic diagram of the various components of used to construct another embodiment of a homogeneous laser light source for use in area processing applications;

FIG. 8 shows a schematic diagram of the various components of used to construct another embodiment of a homogeneous laser light source for use in area processing applications;

FIG. 9 shows a schematic diagram of the various components of used to construct another embodiment of a homogeneous laser light source for use in area processing applications;

FIG. 10 shows a schematic diagram of the various components of used to construct another embodiment of a homogeneous laser light source for use in area processing applications;

FIG. 11 shows block diagram of an embodiment of a homogeneous laser light source for use in area processing applications;

FIG. 12 shows block diagram of an embodiment of a homogeneous laser light source for use in area processing applications having multiple gain amplifiers therein;

FIG. 13 shows block diagram of an embodiment of a homogeneous laser light source for use in area processing applications having multiple laser channels therein, each laser channel in communication with a combiner;

FIG. 14 shows block diagram of an embodiment of a homogeneous laser light source for use in area processing applications having multiple gain channels therein, each gain channel in communication with a combiner;

FIG. 15 shows a schematic diagram of an embodiment of an optical system for use with a homogeneous laser light source for use in area processing applications;

FIG. 16 shows a schematic diagram of the embodiment of an optical system for use with a homogeneous laser light source for use in area processing applications shown in FIG. 15;

FIG. 17 shows a schematic diagram of the embodiment of an optical system installed on an embodiment of a homogeneous laser light source for use in area processing applications shown in FIG. 15;

FIG. 18 shows a schematic diagram of an embodiment of a reflective laser line generator device for use in an optical system configured for use with a homogeneous laser light source for use in area processing applications;

FIG. 19 shows a block diagram of an embodiment of an optical subsystem configured for use with a homogeneous laser light source for use in area processing applications;

FIG. 20 shows a block diagram of another embodiment of an optical subsystem configured for use with a homogeneous laser light source for use in area processing applications;

FIG. 21 shows a chart comparing the performance and benefits of the homogeneous laser light source of the present application to prior art laser systems;

FIG. 22 shows another chart comparing the performance and benefits of the homogeneous laser light source of the present application to prior art laser systems;

FIG. 23 shows another chart comparing the performance and benefits of the homogeneous laser light source of the present application to prior art laser systems; and

FIG. 24 shows another chart comparing the performance and benefits of the homogeneous laser light source of the present application to prior art laser systems;

### DETAILED DESCRIPTION

The present application discloses various embodiments of a homogeneous laser light source. In one embodiment, the laser light source described herein provides a high brightness light source, lacking the temporal mode structure associated with a resonator, and possessing the spatial structure resulting from a multimode beam. The homogenous laser light source disclosed herein has sufficient spectral bandwidth in addition to sufficient spatial incoherence to provide a spatially homogeneous light source desirable for various applications. In another embodiment this spatially homogeneous light source is sufficiently free from speckle and interference effects that cause spatial modulation and would preclude use in many applications. Moreover, in one embodiment, the laser light source disclosed herein may be configured to simultaneously provide very high output power (for example, several hundreds of Watts or greater within a desired wavelength range) while lacking both low-order spatial mode structure associated with a resonator, and the high-order spatial structure resulting from interference of a temporally coherent light source. For example, in one embodiment, the homogeneous laser light source described herein is configured to output about 200 W or greater (to many kilowatts) within a wavelength range of about 300 nm to about 550 nm. As such, some embodiments of the laser light source disclosed herein are well suited for use in laser annealing and other area processing applications, and the like. Those skilled in art will appreciate that the laser light system disclosed herein may be configured for use in a wide variety of applications.

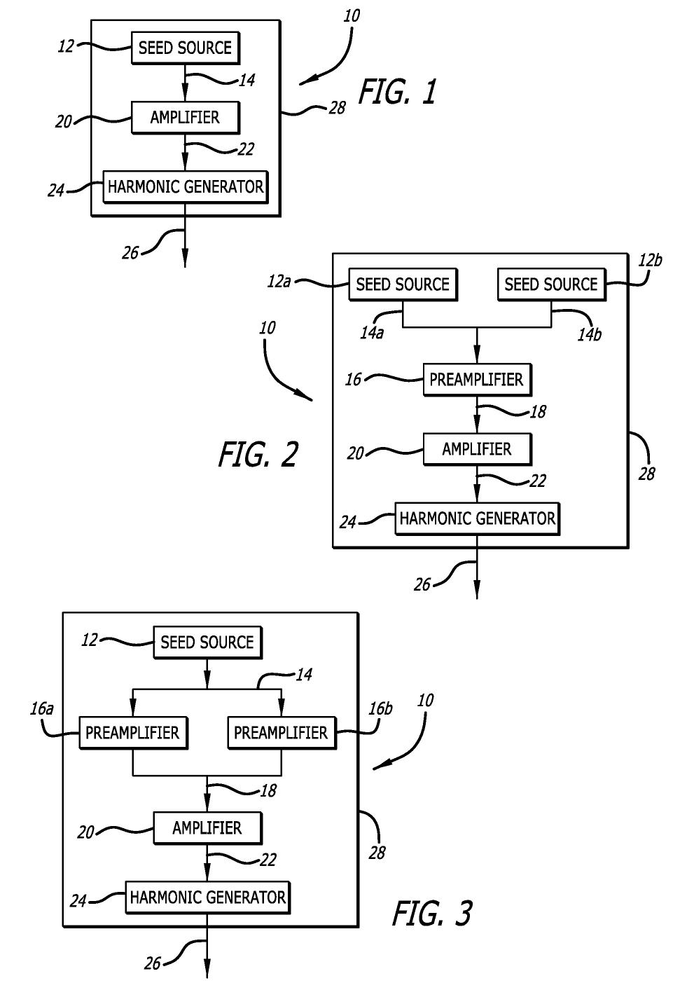

Referring now to FIGS. 1-5, wherein like reference number refer to like elements, various embodiment of a homogeneous laser light source 10 configured to provide a high brightness output signal lacking both low-order spatial mode structure associated with a resonator, and the high-order spatial structure resulting from interference of a coherent light source are presented. As shown in FIGS. 1-5, the homogeneous laser light source 10 includes at least one seed source 12 configured to output at least one seed signal 14. For example, FIGS. 1 and 3-5 show an embodiment of a homogeneous laser light source 10 having a single seed source 12 generating a single seed signal 14. In contrast, FIG. 2 shows an embodiment of a homogeneous laser light source 10 having a first seed source 12a generating a first seed signal 14a and at least a second seed source 12b generating at least a second seed signal 14b. In one embodiment the first and second seed sources 12a, 12b are configured to generate substantially identical seed signals 14a, 14b, wherein the first and second seed signals 14a, 14b have substantially identical wavelengths, bandwidths, powers, polarizations, pulse widths, pulse repetition rates, pulse shape, beam profile, and the like. In another embodiment, the first and second seed sources 12a, 12b comprise seed sources having differing optical characteristics. Exemplary optical characteristics include, without limitations, wavelength, bandwidth, power, polarization, pulse rate, pulse width, pulse repetition rate, and the like. For example, the first seed source 12a may be configured to output a first seed signal 14a having a first polarization while the second seed course 12b may be configured to output a seed signal having a second polarization. Further, at least one of the seed sources 12a, 12b may comprise a modeless seed source configured to generate at least one modeless seed signal 14. In another embodiment, at least one spectral characteristic (i.e. the bandwidth) may be changed. In yet another embodiment, at least one temporal characteristic (i.e. temporal pulse profile, length, and/or width) of the modeless seed signal 14 may be changed. For example, the temporal pulse length of the seed signal 14 may be selectively varied over a range from several tens of picoseconds up to one microsecond, thereby providing a temporally controllable or temporally tailorable light source. Optionally, in another embodiment, the temporal pulse shape of the seed signal 14 may be controlled and changed between substantially constant profile in time over the duration of the pulse to strongly peaked profile in time.

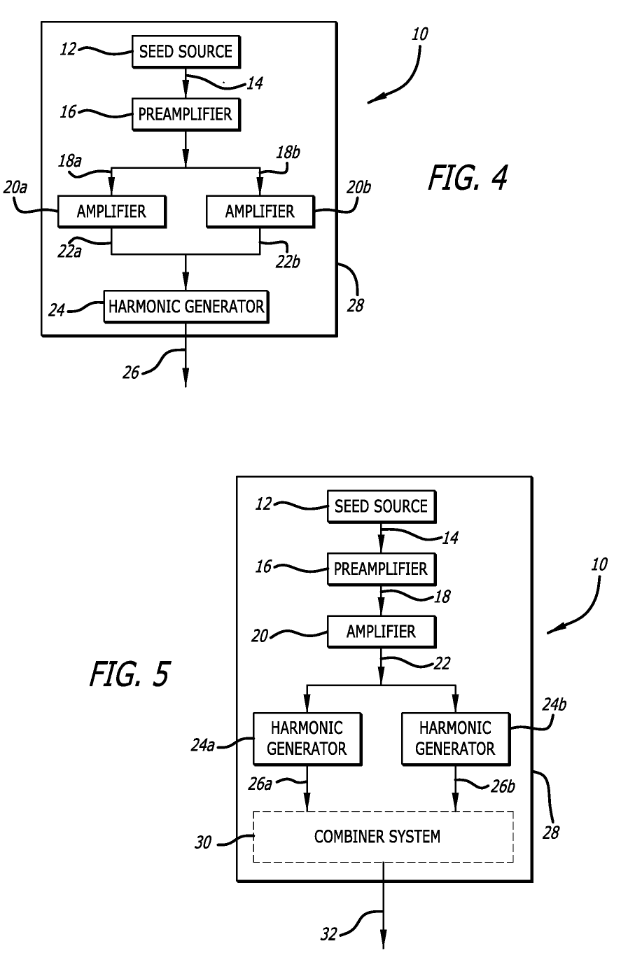

The seed source 12 may be configured to output at least one seed signal 14 to one or more amplifier or amplifiers stages 20. For example, in FIG. 1 at least one modeless seed source 12 outputs at least one modeless seed signal 14 to at least one amplifier 20. In the alternative, as shown in FIGS. 2-5, at least one modeless seed source 12 is configured to output one or more modeless seed signals 14 to one or more preamplifier stages 16 used to pre-condition the modeless seed signal prior to the amplifier stages 20. For example, FIGS. 2-5 show the output of the seed signal 14 (in FIG. 2; first seed signal 14a, second seed signal 14b) is directed into preamplifier 16 (FIG. 3; first preamplifier 16a, second preamplifier 16b) configured to condition or otherwise modify at least one seed signal 14. For example, in one embodiment the preamplifier 16 (FIG. 3; first preamplifier 16a, second preamplifier 16b) is configured to provide at least one stable, low-noise optical preamplifier output signal 18. Optionally, the preamplifier 16 may be configured to increase the average power by a factor of one (1) to one thousand (1000) times and may reshape the temporal shape of the pulses. FIGS. 2, 4 and 5 show an embodiment of a homogeneous laser light source 10 having a single preamplifier 16. In contrast, FIG. 3 shows an alternate embodiment of a homogeneous laser light source 10 having a first preamplifier 16a and at least a second preamplifier 16b. In the embodiment shown in FIG. 3, the output of the first and second preamplifiers 16a, 16b are combined to form a single preamplifier output signal 18, although those skilled in the art will appreciate that any number of preamplifiers 16 may be used in the homogeneous laser light source 10 to form any number of preamplifier output signals 18. For example, FIG. 4 shows an embodiment of preamplifier 16 configured to generate a first preamplifier output signal 18a and at least a second preamplifier output signal 18b. Optionally, the homogeneous light source 10 may be manufactured and/or operated without the inclusion of a preamplifier stage 16 (FIG. 3; first preamplifier 16a, second preamplifier 16b). As such, the modeless seed signal 14 outputted by the modeless seed source 12 may be directly input into an amplifier stage 20, foregoing the need for the preamplifier stage 16.

As shown in FIGS. 1-3, and 5 an embodiment of a homogeneous laser light source 10 having at least one amplifier 20 configured to receive and amplify at least one preamplifier output signal 18. Optionally, the amplifier stage 20 may be configured to receive the seed signal 14 and output at least one amplified signal in response thereto. Further, multiple amplifier stages 20 may be used in the any embodiments shown in FIGS. 1-5. For example, FIG. 4 shows an embodiment of a homogeneous laser light source 10 having a first amplifier 20a configured to generate at a first amplified signal 22a and at least a second amplifier configured to generate at least a second amplifier signal 22b. In one embodiment, the amplifier 20 includes a gated and/or voltage controlled gain. As such, the amplification ratio of the amplifier 20 may be controlled so that it is varied in time. Optionally, those skilled in the art will appreciate that amplifier 20 may be operated without a gated and/or voltage controlled gain. The amplifier may be configured to increase the average power by a factor of one (1) to one thousand (1000) times and may reshape the temporal shape of the pulses. Additional amplifier stages may be added to increase the power to kilowatts if desired.

Referring again to FIGS. 1-5, the amplifier 20 (or amplifiers 20a, 20b in FIG. 4) outputs at least one amplified signal 22 which may be directed to at least one nonlinear optical generator. In the FIGS. 1-5, the nonlinear optical generator comprises at least one harmonic generator 24, although those skilled in the art will appreciate that any variety of nonlinear optical generators could be used in the present system. Exemplary alternate nonlinear optical generators include, without limitations, optical parametric oscillators, difference frequency generators, sum frequency generators, and the like. In one embodiment, the amplified signal 22 may comprise a modeless amplified signal 22. For example, if a modeless seed signal 14 (See FIG. 1) and/or modeless preamplifier signal 18 is directed into at least one amplifier 20 at least one modeless amplifier signal 22 may be output therefrom. Optionally, multiple amplifier stages may be used in the laser system 10. For example, FIG. 4 shows the amplifiers 20a, 20b outputting a first and second amplified signal 22a, 22b to at least one harmonic generator 24. As shown in FIG. 1-4, a single harmonic generator 24 may be included in the homogeneous laser light source 10. In the alternative, one or more harmonic generators 24 may be included in the laser light source. For example, FIG. 5 shows an embodiment of homogeneous laser light source 10 having a first harmonic generator 24a configured to output at a first harmonic output signal 26a and at least a second harmonic generator or supplemental system 24b configured to output at least a second harmonic output signal or supplemental signal 26b. In one embodiment, the first and second harmonic output signals 26a, 26b are substantially the same wavelength. In another embodiment, the first and second harmonic output signals 26a, 26b are different wavelengths. In addition, the harmonic generator 24 may be configured to output at least one modeless harmonic signal 26 based on at least one modeless amplifier signal 22 being directed into the harmonic generator 24. Further, the first and second harmonic output signals 26a, 26b may have substantially the same or differing optical characteristics, including, for example, wavelength, bandwidth, power, polarization, pulse width, pulse repetition rate, pulse shape, beam profile, and the like. Further, one or more combiner systems or additional optical components or subsystems 30 may be used to combine the first and second harmonic output signals 26a, 26b to produce a system output 32. Exemplary additional optical subsystems 30 include, without limitations, lenses, mirrors, beam directors, sensors, detectors, gratings, prisms, mode scramblers, mode shapers, optical fibers, controllers, processors, attenuators, computer networks, and the like.

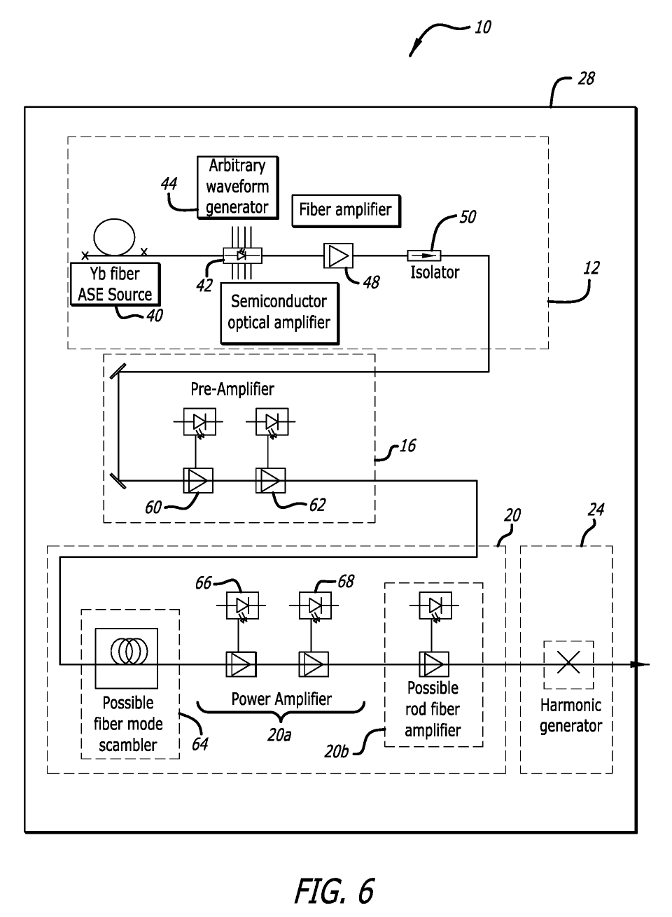

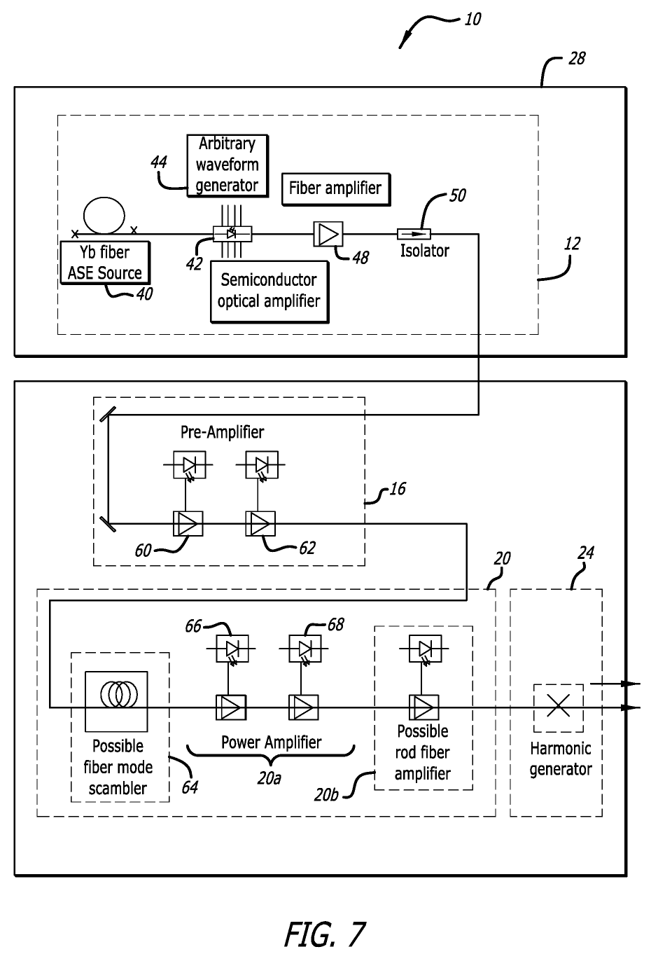

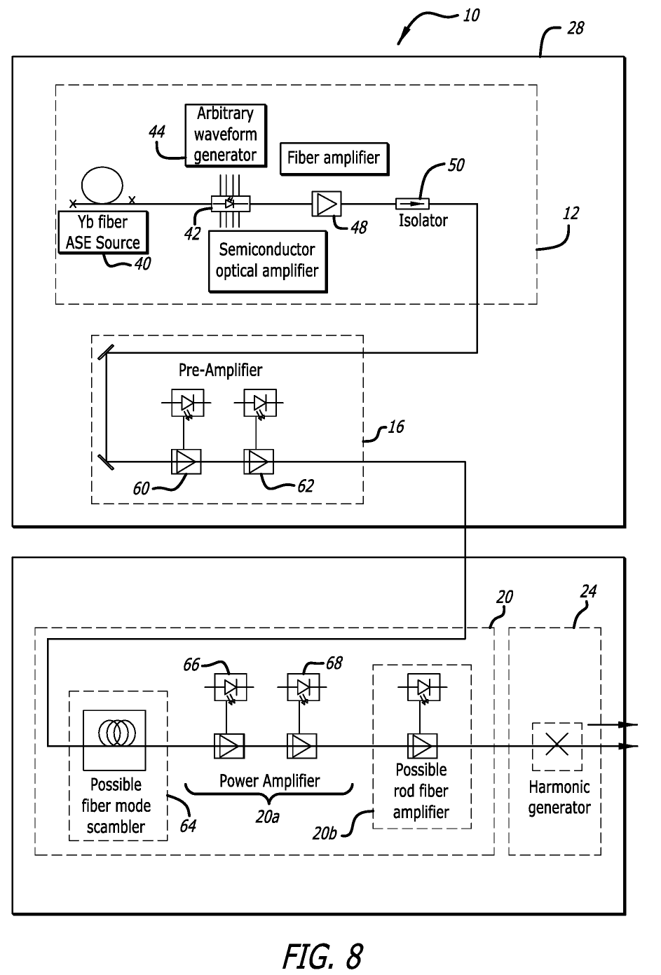

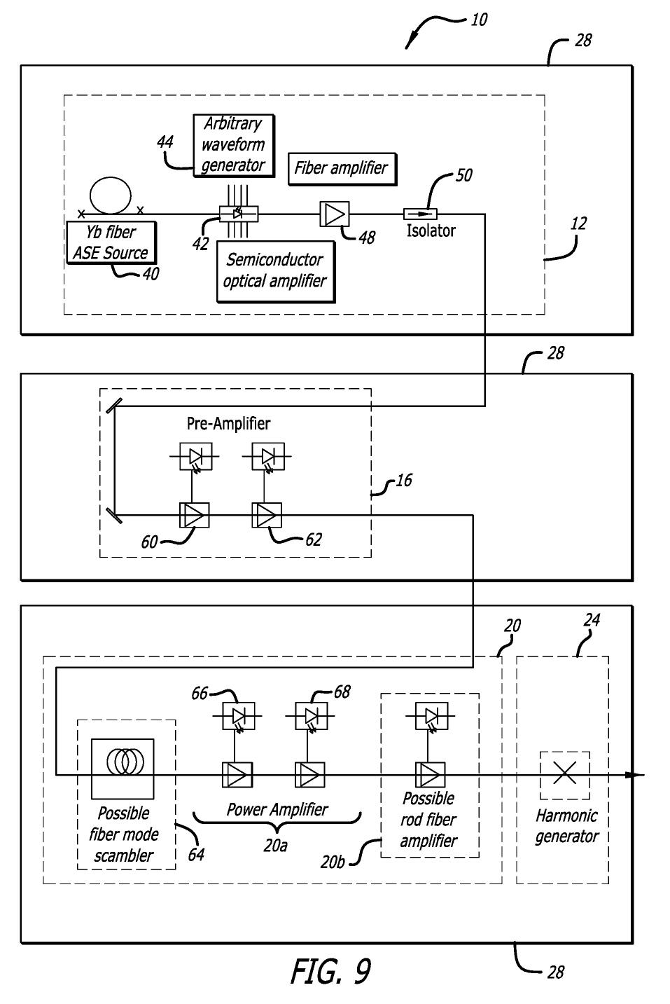

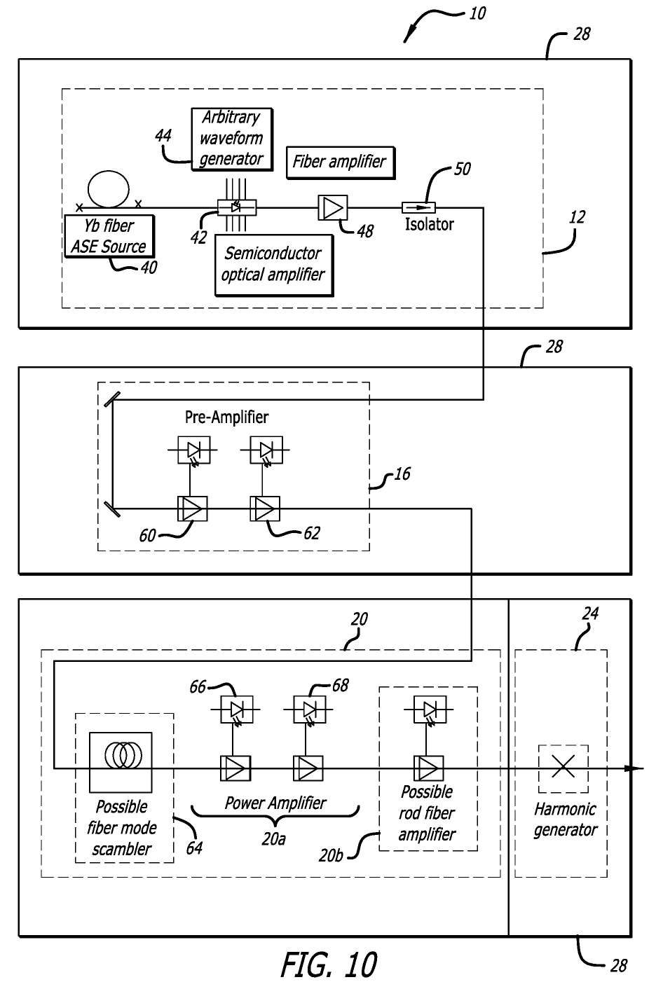

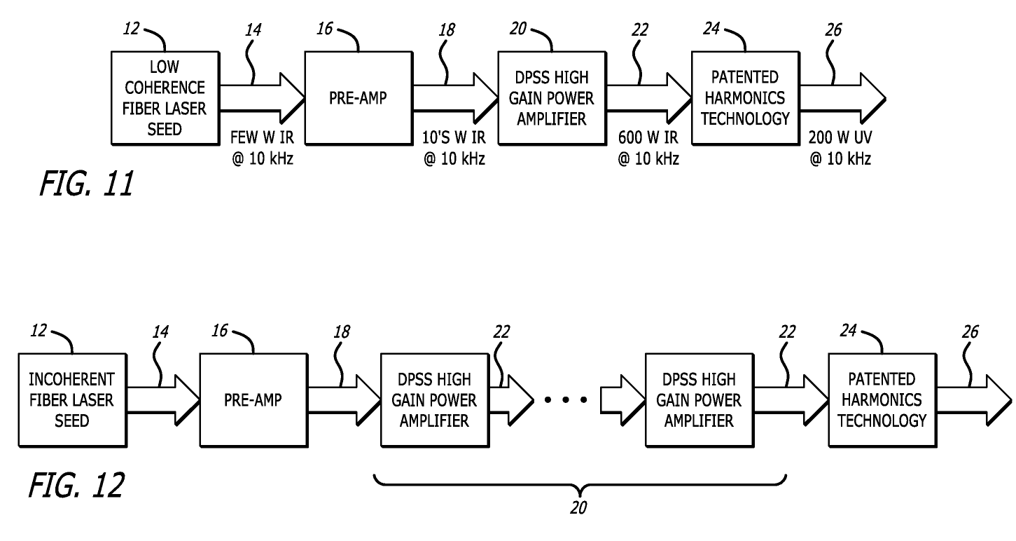

FIGS. 1-14 show various embodiments of a homogenous laser light source 10 and the various components and subsystems thereof. In the embodiments shown in FIGS. 1-6, the various components and subsystems forming the homogenous laser light source are enclosed within a single enclosure or housing 28. In contrast, FIGS. 7-10 shows various subsystems of the homogenous laser light source 10 located in multiple housings, thereby creating a modular homogenous laser light system 10. As shown, in one embodiment of a homogeneous laser light source 10 as generally described above, wherein like reference number refer to like elements, the homogenous laser light source 10 include at least one seed source 12 configured to output a seed signal 14 to at least one preamplifier 16 illustrated embodiment. The seed source 12 may include at least one temporally incoherent low power light source 40. The incoherent low power seed source 40 described herein provides a high brightness light source, lacking the temporal mode structure associated with a resonator. Optionally, the seed source 12 may include one or more temporally incoherent high power light sources. In one embodiment, the seed source 12 may comprise a modeless seed source configured to output at least one modeless seed source signal 14 (See FIG. 1). Optionally, any variety of low coherence or incoherent light sources may be used in the seed source 12, including, without limitations, fiber laser light sources, Yb fiber light sources, Amplified Spontaneous Emission sources (hereinafter ASE sources), laser diodes, superluminescent diodes, incoherent combined fiber laser devices and systems, and the like. In one specific embodiment, the seed source includes at least one Quasar™ laser system manufactured by Spectra-Physics™, although those skilled in the art will appreciate that any low coherence light source may be used with the present system.

Referring again to FIGS. 1-14, in addition to the presence or absence of mode structure, the bandwidth of the seed source 12 and ultimately the bandwidth of the output signal 32 maybe used to determining both the homogeneity and efficiency of the laser light source 10. For a more homogeneous source, larger bandwidths may be desired, as the effects of speckle are reduced. ASE sources, Yb fiber sources and superluminescent diode sources may be configured to output as much as 100 nm or more of bandwidth. Further, fiber amplifier systems can amplify this bandwidth and bulk gain media (e.g. Yb gain media) or other gain media devices may be configured to amplify many tens of nanometers of bandwidth. Harmonic conversion crystals however, exhibit reduced efficiency with increasing bandwidth. For example, some second and third harmonic generation (e.g. LBO) may exhibit reduced efficiency once the bandwidth exceeds a few nanometers. For high peak power systems, shorter crystals with a larger acceptance bandwidth may be used and other nonlinear crystals with larger acceptance bandwidths, such as BBO and the like, periodically polled materials, and similar materials etc. may also be employed. Thus, the bandwidth of the seed source 12, regardless of whether it is a mode-less seed source or not, may be chosen to produce an output signal 32 having a final bandwidth that satisfies both the requirements of homogeneity and efficiency.

In addition to the presence or absence of mode structure, the bandwidth of the seed source and ultimately the bandwidth of the final system output are important in determining both the homogeneity and efficiency of the source. For a more homogeneous source, larger bandwidths are desired, as the effects of speckle are reduced. ASE sources, Yb fiber sources and superluminescent diode sources can all output as much as 100 nm of bandwidth. Fiber amplifier systems can amplify this bandwidth and bulk Yb gain media can amplify many 10 s of nm of bandwidth. Harmonic conversion crystals however, exhibit reduced efficiency with increasing bandwidth. For example, second and third harmonic generation in LBO will exhibit reduced efficiency once the bandwidth exceeds a few nm. For high peak power systems, shorter crystals with a larger acceptance bandwidth can be used and other nonlinear crystals with larger acceptance bandwidths, such as BBO etc. can also be employed. Thus the bandwidth of the seed source, regardless of whether it is a mode-less seed source or not, can be chosen to produce a final bandwidth from the system that satisfies both the requirements of homogeneity and efficiency.

Referring again to FIGS. 1-14, the seed source 12 may optionally include additional elements or components therein. For example, in one embodiment, the seed source 12 includes one or more semiconductor amplifiers 42 therein. In addition, one or more arbitrary waveform generators 44 may be included within or in contact with the seed source 12. In some embodiments, the seed source 12 includes at least one fiber amplifier 48 and at least one isolator 50 therein, although those skilled in the art will appreciate that the seed source need not include a fiber amplifier 48 and an isolator 50.

As shown in FIGS. 1-14, the seed signal 14 from the seed source 12 may be directed into at least one preamplifier 16. In some embodiments, the preamplifier 16 is co-located within the same housing 28 as the seed source 12 (See FIGS. 1-6 and 8). As stated above, the homogeneous laser light source 10 need not include a preamplifier 16. Rather, the homogeneous laser light source 10 may include a directed seeded amplifier 20 wherein the amplifier 20 is configured to receive the seed signal (modeless or not) from the seed source 12. In other embodiments, the preamplifier 16 may be positioned within a separate housing from the seed source 12. Optionally, the preamplifier 16 may include any number of preamplifier modules therein. In the illustrated embodiment, the preamplifier 16 includes a first preamplifier module 60 and at least a second preamplifier module 62. Additional preamplifier modules may be selectively added or removed from the preamplifier 16. Those skilled in the art will appreciate that the preamplifier may include at least one bulk preamplifier and/or at least one fiber preamplifier. That fiber preamplifier may consist of a large mode area fiber amplifier configured to minimize nonlinear effects. Optionally, the large mode area fiber may consist of at least one single crystal, large mode area fiber preamplifier.

Referring again to FIGS. 1-14, the preamplifier output signal 18 may be directed into at least one amplifier 20. For example, as shown in FIGS. 4, 12, and 14, in some embodiments multiple amplifiers 20 may be used in the homogenous laser light source 10. In one embodiment at least one power amplifier 20a and at least one fiber amplifier 20b may be used in the homogenous laser light source 10. In another embodiment, at least one diode pumped solid state high gain amplifier (hereinafter DPSS amplifier) is included in the amplifier 20. As such, multiple amplifiers 20 of the same type, power, and the like may be used in the homogenous laser light source 10. In another embodiment, multiple amplifiers 20 of differing types, powers, and the like may be used in the homogenous laser light source 10. Optionally, the amplifier 20 may be positioned within the same housing 28 as at least one of the seed source 12 and preamplifier 16 or, in the alternative, positioned within a separate housing 28.

In one embodiment, the amplifier 20 includes at least one gain material or media therein. For example, the amplifier 20 may include at least one Neodymium-doped (hereinafter Nd-doped) vanadate device whose gain properties allow very high gain (e.g. saturated gain greater than ten (10) over several centimeters of material). Directly diode pumping of the gain media, which may be positioned within the amplifier, to their upper laser exited state may reduce as much as thirty percent (30%) of the waste heat deposited into the gain medium, thereby reducing excess temperature excursions in the gain medium. In another embodiment, the homogenous laser light source 10 includes at least one multi-mode fiber configured to transmit the low-power light between two of the low-power amplifier stages effectively scrambling the input structured beam in a predictable way to achieve spatial homogeneity in the transverse plane to laser beam propagation. Optionally, all amplification stages of a multi-stage amplifier 20 as described herein may be composed of at least one broadband gain medium to achieve simultaneously wide-band amplification and high output. Examples of such a gain material include Ytterbium doped YAG, Ytterbium doped YALO, Ytterbium doped vanadate, Ytterbium doped CALGO, Ytterbium doped lutetium, Ytterbium doped, Calcium Fluoride (CaF₂) and the like. The output light 22 of the present embodiment could offer a much more broad spectrum, up to several nm of linewidth, up to the limit of what can be converted in a subsequent stage of frequency doubling by the harmonic generator 24. The output light 22 could alternatively offer an even broader spectrum than what could be converted by the harmonic generator 24. While the embodiments shown in FIGS. 1-14 include at least one harmonic generator 24, as stated above any variety of nonlinear optical generator could be substituted into the present system to replace or in addition to the harmonic generator 24. Exemplary alternate nonlinear optical generators include, without limitations, optical parametric oscillators, difference frequency generators, sum frequency generators, and the like.

In another embodiment, a gain element located within the amplifier 20 may be manufactured in the shape of a fiber optic device or similar fiber element but larger in diameter than typical single mode fibers. As such, the fiber optic device or similar fiber element may be drawn in a rigid form, or in the alternative, in a compliant form. As a result, the cylindrical gain device described herein will supply gain to the incoming preamplifier signal 18, while the multiple bounce pattern of the fiber transmission has the effect of homogenizing the beam and substantially broadening the spatial mode spectrum with advantageous effect. Optionally, the amplifier 20 may include any number of amplifier modules therein. In the illustrated embodiment, a first amplifier module 66 and at least a second amplifier module 68 are used to form at least one amplifier 20. In addition, the amplifier 20 may include one or more additional elements of components therein. For example, in the illustrated embodiments at least one fiber mode scrambler 64 may be included within the amplifier 20, although those skilled in the art will appreciate that at least one scrambler may be positioned anywhere within the system.

As shown in FIGS. 1-14, the amplified output 22 of the amplifier 20 is directed into at least one harmonic generator 24 to produce at least one harmonic output 26. For example, FIG. 14 shows an embodiment of a homogenous laser light source 10 having multiple harmonic generators 24 in communication with multiple amplifiers 20, each harmonic generator 24 configured to output at least one harmonic output 26 to at least one optical subsystems 30. Optionally, any number of harmonic generators 24 may be included within the homogenous laser light source 10. In one embodiment, the harmonic generator 24 may be positioned within the same housing 28 as at least one of the seed source 12, preamplifier 16, and amplifier 20 or, in the alternative, positioned within a separate housing 28. The harmonic generator 24 may be configured to generate at least one harmonic output in response to being irradiated with the amplifier signal 22. In one embodiment, the harmonic generator output signal 26 has a wavelength from about 50 nm to about 1500 nm. In another embodiment, the harmonic generator output signal 26 has a wavelength of about from about 100 nm to about 400 nm. Optionally, the harmonic generator output signal 26 has a wavelength of about from about 300 nm to about 550 nm, although those skilled in the art will appreciate that the harmonic generator 24 may be configured to output at least one harmonic output signal 26 at any desired wavelength, dependent on the wavelength of the amplified signal 22. In one embodiment, the harmonic generator 24 includes at least one crystal configured to output a second harmonic of an input signal. In another embodiment, the harmonic generator 24 includes at least one crystal configured to output a third harmonic of an input signal. In another embodiment, the harmonic generator 24 includes at least one crystal configured to output a fourth harmonic of an input signal. In short, the harmonic generator 24 may be configured to output any harmonic of an input signal. In some applications at least a portion of the seed signal 14, preamplifier output signal 18, and/or amplified signal 22 may also be emitted from the homogenous laser light source 10.

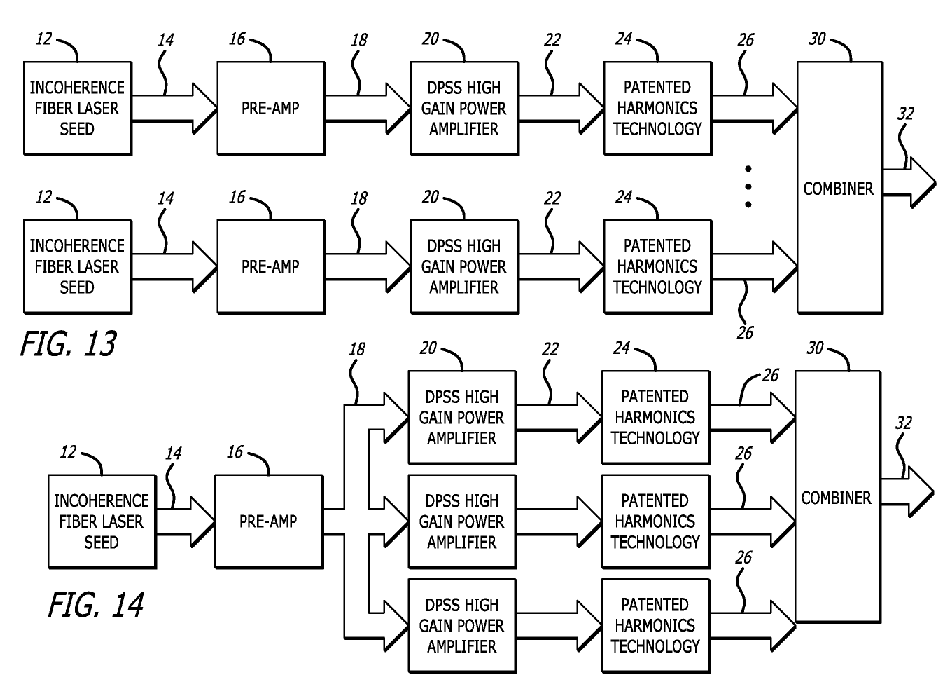

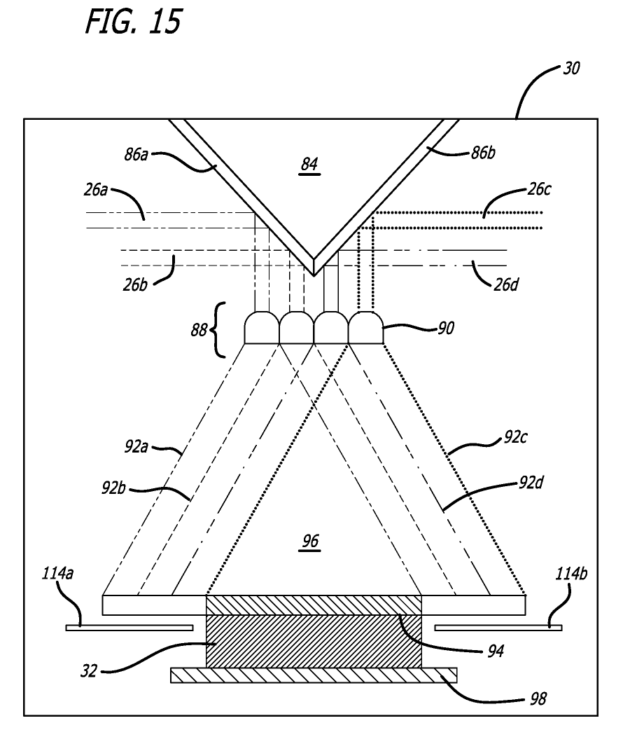

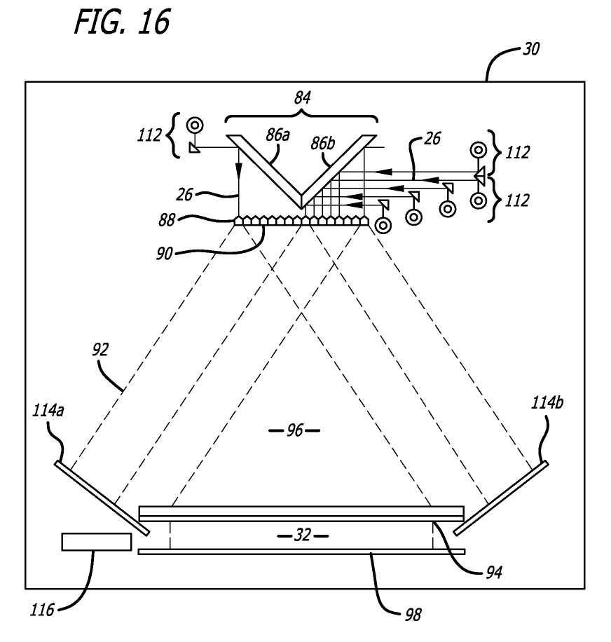

FIGS. 13 and 14 show various embodiments of a homogenous laser light source 10 which includes an optical subsystems or combiner 30 to condition, modify, and/or combine the harmonic signals 26 of one or more harmonic generators 24. Those skilled in the art will appreciate that any of the embodiments of the homogenous laser light source 10 shown herein may include at least one optical subsystem or combiner 30 to condition, modify, and/or combine the harmonic signals 26 of one or more harmonic generators 24 or other signals generated within the homogenous laser light source 10. FIGS. 15 and 16 show various views of embodiments of the optical subsystem 30 shown in FIGS. 13 and 14. As shown, the optical subsystem 30 may be configured to receive at least one optical signal therein and condition, modify, and/or combine the optical signal to produce at least one system output signal. For example, as shown in FIGS. 15, the optical subsystem 30 is configured to receive harmonic signals 26a, 26b, 26c, and 26d from one or more harmonic generators 24 and/or supplemental systems 24b (see FIGS. 5, 13, 14) therein. FIG. 16 shows an optical subsystem 30 having multiple harmonic signals 26 incident thereon. Those skilled in the art will appreciate that any number of harmonic signals 26 may be used with the embodiments of the optical subsystems 30 shown in FIGS. 15 and 16. In one embodiment, the harmonic signals 26a, 26b, 26c, and 26d shown in FIG. 15 and harmonic signals 26 shown in FIG. 16 are directed to at least one laser line generator device 88 by at least one beam director 84. In the illustrated embodiment, the beam director 84 includes a first director body 86a and a second director body 86b, although those skilled in the art will appreciate that the beam director 84 may include any number of director bodies. Exemplary beam directors 84 include, without limitations, flat mirrors, arcuate mirrors, gratings, fold mirrors, prisms, rhombs, and the like. In the illustrated embodiments, the beam director bodies 86a, 86b comprise substantially planar reflectors. In another embodiment, at least one of the first and second director body 86a, 86b may comprise a non-planar body, such as, for example, an arcuate reflector.

Optionally, one or more periscopes, lenses, optical suites, optical fibers, filters, gratings, and the like may be used to condition or direct at least a portion of the harmonic signals 26a-26d to the beam director 84. For example, one or more periscopes may be used to receive the harmonic signals 26a-26d from at least one harmonic generator 24 and direct the harmonic signals 26a-26d to at least one of the first and second director bodies 86a, 86b of the beam director 84. FIG. 16 shows an embodiment of an optical subsystem 30 having multiple periscope assemblies 112 configured to receive at least one harmonic signal 26 from the harmonic generators 24 shown in FIGS. 1-14.

Referring again to FIGS. 13-16, at least one laser line generator device 88 may be used to condition the harmonic signals 26a-26d to produce at least one output signal 32 having a desired irradiance profile. In one embodiment, the laser line generator 88 comprises one or more line generator members 90. In the illustrated embodiment at least one line generator member 90 comprises a Powell lens. As such, the laser line generator device 88 may be comprised of multiple Powell lenses, the Powell lenses acting as individual line generator members 90. Any number of line generator members 90 may be used to form the laser line generator device. In general, Powell lenses include a complex two-dimensional aspheric curve body which is configured to generate very high spherical aberration which redistributes the input light along a line. As such, the substantially Gaussian intensity profile of the harmonic signals 26a-26d incident on the line generator members 90 is redistributed to produce at least one laser line output signal 92 having substantially uniform intensity in one direction. For example, FIG. 15 shows an embodiment wherein four laser line output signals 92a-92d are output by the line generator devices 90 of the laser line generator device 88, each laser line output signal 92a-92d having substantially uniform intensity. Similarly, FIG. 16 shows an embodiment wherein three laser line output signals 92 having substantially uniform intensity are output by the line generator devices 90 of the laser line generator device 88. In one embodiment, the number of laser line output signals 92 will coincide with the number of line generator members 90 used in forming the laser line generator device 88. For example, 16 line generator members 90 will output approximately 16 laser line output signals 92, each laser line output signal 92 having uniform intensity. In another embodiment, at least one line generator member 90 comprises at least one cylindrical lens. Optionally, the line generator member 90 comprises one or more aspheric lens or lens systems configured to redistribute the substantially Gaussian intensity profile of an incident optical signal to produce at least one output signal 32 having substantially uniform intensity in one direction. Those skilled in the art will appreciate that the line generator member 90 may comprise any number of additional or alternative optics such as: refractive optics, refractive beam shapers, diffractive optics, diffractive beam shapers and the like. Further, in the illustrated embodiment, the laser line generator device 88 comprises a substantially planar body. Optionally, the laser line generator device 88 may comprise a substantially arcuate body. Further, the laser line generator device 88 may be formed in any variety of shapes, sizes, and/or configurations.

As shown in FIGS. 13-16, at least a portion of each laser line output signal overlaps or is super-imposed on an adjacent laser line output signal. For example, as shown in FIG. 15, the laser line output signals 92a-92d are coincidental. As such, at least one composite optical signal 96 having generally uniform intensity is formed from the summation of overlapping adjacent laser line output signals 92a-92d. Similarly, FIG. 16 shows at least one composite optical signal 96 is created by the summation of the adjacent laser line signals 92. The composite optical signal 96 may be directed to at least one condensing lens or other optical system 94 configured to condition, focus, or otherwise modify the composite optical signal 96 to output at least one output signal 32 which may be directed to at least one specimen, sample, substrate, or element undergoing processing. In one embodiment, the condensing lens 94 comprises at least one cylindrical lens, although any variety or number of condensing devices may be used. In the illustrated embodiment, one or more beam dumps or reflectors 114a, 114b may be included to define the composite optical signal 96 or otherwise modify the output signal 32. Optionally, any number of additional optical elements, cameras, detectors, optical stages, controllers, sensors, and the like may be included within the system. For example, as shown in FIG. 16 at least one camera may be used examine the substrate during a processing sequence, such as during a surface annealing process.

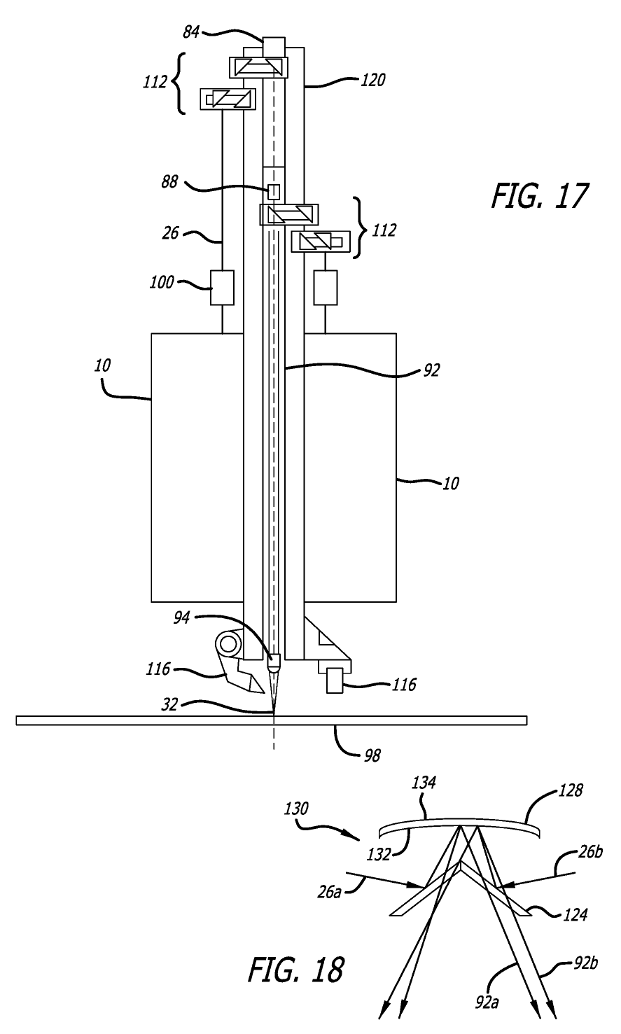

FIGS. 15 and 16 show various embodiment of the optical subsystem 30 from a first orientation. In contrast, FIG. 17 show an embodiment of the optical subsystem 30 coupled to at least one laser system 10 as viewed from a second orientation. As shown, two laser systems 10 are coupled to a system frame member 120 which may be configured to be selectively movable or fixed at a desired location. The harmonic output signals 26 of the laser systems 10 may be directed into one or more optical components or devices 100. For example, one or more collimators, beam expanders, and the like may be used to condition or otherwise modify the harmonic output signals 26. Thereafter, the harmonic output signals 26 may be directed into the optical subsystem 30 using one or more periscopes assemblies, which may include various motors, gimbals, stages, optical elements, and the like. Thereafter, as described above, the harmonic optical signals 26 are directed to the laser line generator device 88 by the beam director 84. In the illustrated embodiment, only a single laser line generator device 88 is shown in this orientation within the optical subsystem 30. Those skilled in the art will appreciate that any number of laser line generator devices 88 positioned in the same or differing orientations, may be used in the optical subsystem 30. The laser line generator device 88 modifies the harmonic signal 26 to produce at least one laser line 92 which is directed to the condensing device 94. The condensing device 94 focuses the laser line and outputs at least one output signal to at least one substrate or specimen 98. One or more cameras or sensors 116 may be used to monitor the processing of the substrate.

The embodiments of the optical subsystem 30 shown in FIGS. 15-17 include a refractive laser line generator device 88. In contrast, FIG. 18 shows an embodiment of a reflective laser line generator device 128. As shown, the harmonic signals 26a, 26b are directed by the beam director 124 to the reflective laser line generator 128 which generates one or more laser lines 92a, 92b which may be directed to the condensing device 94 (See FIGS. 15-17). In the illustrated embodiment, the laser line generator device 128 comprises an arcuate body, although those skilled in the art will appreciate that the laser line generator device 128 may be formed in any variety of configurations. Like the previous embodiment, the laser line generator device 128 may include one or more Powell lenses or elements, cylindrical lens, aspheric optical elements, and the like. Optionally, the any surface of the laser line generator device 128 may include one or more line generator members (not shown) formed thereon. For example, the first surface 132, the second surface 134, or both may include one or more line generator members (not shown) formed thereon. Those skilled in the art will also appreciate that a diffractive laser line generator device 88 could also be used.

In another embodiment there are about 16 harmonic signals 26 from harmonic generators 24 that are combined in optical subsystem or combiner 30 to generate many kilowatts of composite optical signal 96 or output signal 32. In this embodiment the addition of harmonic signals 26 can improve the spatial uniformity by averaging the composite optical signal 96 or output signal 32. In one embodiment the combination of this spatial averaging together with the properties of the homogeneous laser light source results in a spatial intensity variation at the substrate or specimen 98 of less than 10%. In another embodiment the spatial intensity variation at the substrate or specimen 98 is less than 5%. In yet another embodiment the spatial intensity variation at the substrate or specimen 98 is less than 1%.

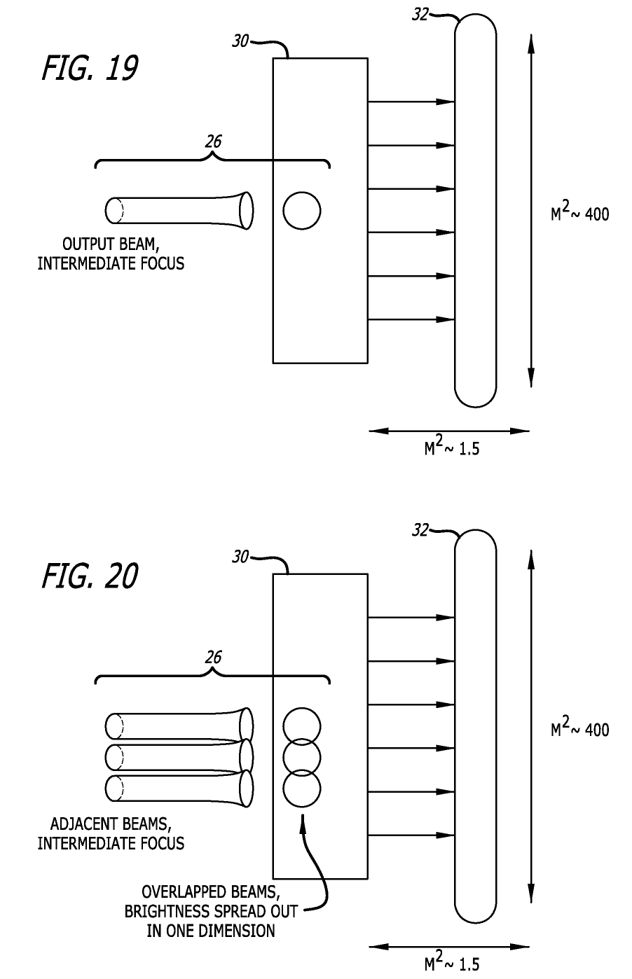

FIGS. 19 and 20 show the conversion of the Gaussian harmonic signal 26 to the output signal 32 having a substantially uniform intensity by the optical subsystem 30. As shown in FIG. 19, a single harmonic signal 26 having a substantially Gaussian intensity profile in both directions and is directed into the optical subsystem 30. The optical subsystem described in FIGS. 15-18 above, modify the intensity profile of the harmonic signal 26 to produce the output signal 32 having a substantially uniform intensity profile in one direction and a substantially Gaussian intensity distribution on the other direction. In contrast, FIG. 20 shows multiple harmonic signals 26, each having a substantially Gaussian intensity profile, which are directed into the optical subsystem 30. The harmonic signals 26 are made to overlap by the optical subsystem. Further, the optical subsystem described in FIGS. 15-18 above, modify the intensity profile of the overlapping harmonic signals 26 to produce the output signal 32 having a substantially uniform intensity profile in one direction.

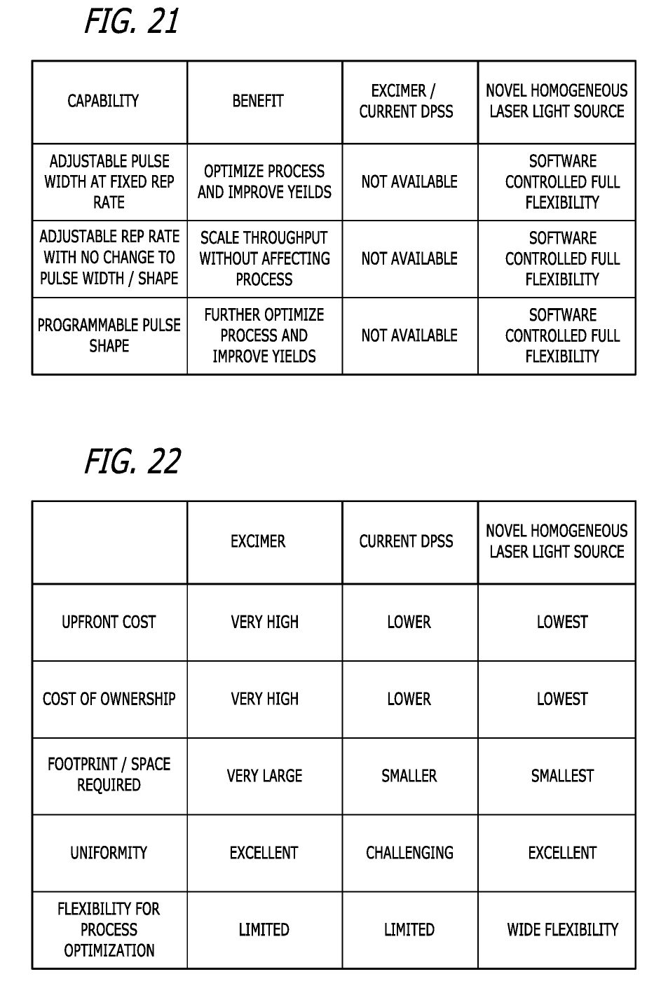

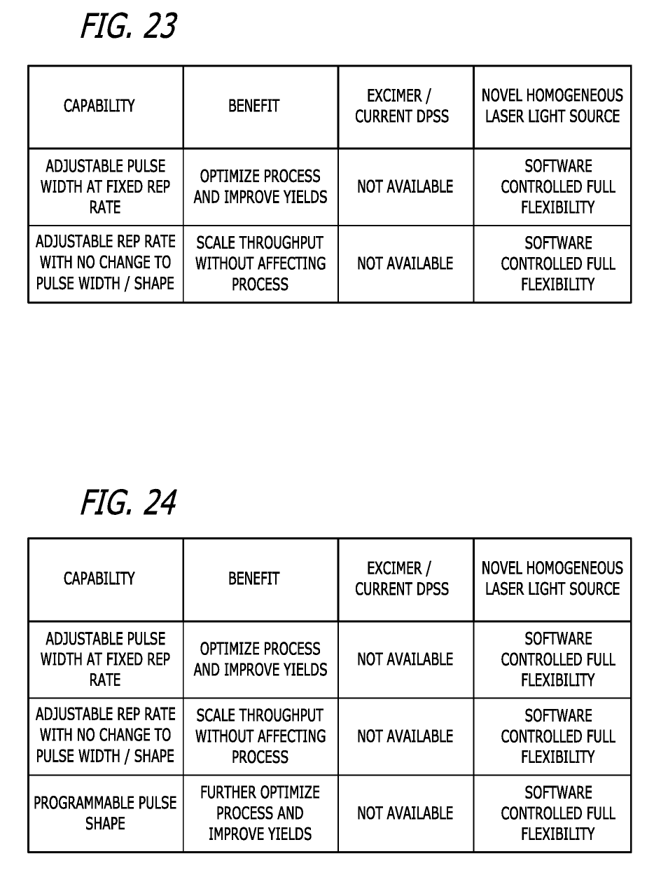

FIGS. 21-24 show graphically the advantages of the novel homogenous laser light source disclosed herein as compared with prior art laser system used in laser annealing applications. As shown, the novel homogenous laser light source disclosed herein offer improved performance and flexibility at a lower cost as compared with the prior art systems. Further, the embodiments disclosed herein are illustrative of the principles of the invention. Other modifications may be employed which are within the scope of the invention. Accordingly, the devices disclosed herein are not limited to that precisely as shown and described herein. Further, while the present application discloses the use of the homogeneous laser light source for use in large area processing and the like, those skilled in the art will appreciate that the homogeneous laser light disclosed herein may be used in any variety of additional applications, including, without limitations, treating or examining biological tissue, inspection of parts and/or materials, and the like.

What is claimed:

1. A homogeneous laser light source, comprising
at least one modeless seed source configured to output at least one modeless seed signal;
at least one amplifier in communication and configured to receive the at least one modeless seed signal and output at least one modeless amplifier signal; and
at least one nonlinear optical generator is communication with the at least one amplifier, the at least one nonlinear optical generator configured to generate at least one modeless harmonic output signal in response to the at least one modeless amplifier signal, wherein a wavelength of the at least one modeless harmonic output signal is different than a wavelength of the at least one modeless amplifier signal.

2. The homogeneous laser light source of claim 1 wherein the at least one modeless seed source includes at least one low coherence light source therein.

3. The homogeneous laser light source of claim 2 wherein the at least one low coherence light source comprises at least one fiber seed laser light source.

4. The homogeneous laser light source of claim 2 wherein the at least one low coherence light source comprises at least one Yb fiber seed laser light source.

5. The homogeneous laser light source of claim 2 wherein the at least one low coherence light source comprises at least one amplified spontaneous emission light source.

6. The homogeneous laser light source of claim 1 wherein the at least one modeless seed source includes at least one incoherent light source therein.

7. The homogeneous laser light source of claim 6 wherein the at least one incoherent light source comprises at least one superluminescent light source.

8. The homogeneous laser light source of claim 1 wherein the at least one modeless seed source includes at least one arbitrary waveform generator therein.

9. The homogeneous laser light source of claim 1 wherein the at least one modeless seed source includes at least one semiconductor optical amplifier therein.

10. The homogeneous laser light source of claim 1 wherein the at least one modeless seed source includes at least one fiber amplifier therein.

11. The homogeneous laser light source of claim 1 wherein the at least one modeless seed source includes at least one isolator therein.

12. The homogeneous laser light source of claim 1 wherein the at least one amplifier further comprises:
at least one preamplifier in optical communication with the at least one modeless seed source, the at least one modeless preamplifier configured to receive the at least one modeless seed signal from the at least one modeless seed source and generate at least one modeless preamplifier signal in response thereto; and
at least one amplifier in optical communication with the at least one preamplifier and configured to receive the at least one modeless preamplifier signal from the at least one preamplifier and generate at least one modeless amplifier signal in response thereto.

13. The homogeneous laser light source of claim 12 wherein the at least one preamplifier includes at least one bulk preamplifier.

14. The homogeneous laser light source of claim 12 wherein the at least one preamplifier includes at least one fiber preamplifier.

15. The homogeneous laser light source of claim 14 wherein the at least one preamplifier includes at least one large mode area fiber preamplifier configured to minimize nonlinear effects.

16. The homogeneous laser light source of claim 14 wherein the at least one preamplifier includes at least one single crystal, large mode area fiber preamplifier.

17. The homogeneous laser light source of claim 1 wherein the at least one amplifier includes at least one fiber mode scrambler.

18. The homogeneous laser light source of claim 1 wherein the at least one amplifier comprises at least one Neodymium-doped vanadate gain device.

19. The homogeneous laser light source of claim 1 wherein the at least one amplifier includes at least one Ytterbium doped YAG gain device.

20. The homogeneous laser light source of claim 1 wherein the at least one amplifier includes at least one Ytterbium doped YALO gain device.

21. The homogeneous laser light source of claim 1 wherein the at least one amplifier includes at least one Ytterbium doped vanadate gain device.

22. The homogeneous laser light source of claim 1 wherein the at least one amplifier includes at least one Ytterbium doped CALGO gain device.

23. The homogeneous laser light source of claim 1 wherein the at least one amplifier includes at least one Ytterbium doped lutetium gain device.

24. The homogeneous laser light source of claim 1 wherein the at least one amplifier includes at least one Calcium Fluoride gain device.

25. The homogeneous laser light source of claim 1 wherein the at least one amplifier includes at least one multi-mode fiber amplifier gain device.

26. The homogeneous laser light source of claim 1 wherein the at least one amplifier includes at least one fiber rod amplifier.

27. The homogeneous laser light source of claim 1 wherein the at least one amplifier includes a voltage controlled gain.

28. The homogeneous laser light source of claim 1 wherein the at least one modeless harmonic output signal has a wavelength from about 50 nm to about 1500 nm.

29. The homogeneous laser light source of claim 1 wherein the at least one modeless harmonic output signal has a wavelength from about 100 nm to about 400 nm.

30. The homogeneous laser light source of claim 1 wherein the at least one modeless harmonic output signal has a wavelength from about 300 nm to about 550 nm.

31. The homogeneous laser light source of claim 1 wherein the at least one nonlinear optical generator includes at least one optical crystal configured to at least one modeless harmonic output signal having a wavelength which comprises a second harmonic of the at least one modeless amplifier signal.

32. The homogeneous laser light source of claim 1 wherein the at least one nonlinear optical generator includes at least one optical crystal configured to at least one modeless harmonic output signal having a wavelength which comprises a third harmonic of the at least one modeless amplifier signal.

33. The homogeneous laser light source of claim 1 wherein the at least one nonlinear optical generator includes at least one optical crystal configured to at least one modeless harmonic output signal having a wavelength which comprises a fourth harmonic of the at least one modeless amplifier signal.

34. The homogeneous laser light source of claim 1 wherein the at least one nonlinear optical generator includes at least one optical crystal configured to at least one modeless harmonic output signal having a wavelength which comprises a harmonic of the at least one modeless amplifier signal.

35. The homogeneous laser light source of claim 1 further comprising at least one optical subsystem in optical communication with the at least one nonlinear optical generator.

36. The homogeneous laser light source of claim 35 wherein the at least one optical subsystem in optical communication with the at least one nonlinear optical generator comprises one or more combiner systems configured to combine multiple wavelengths of the at least one modeless harmonic output signal.

37. The homogeneous laser light source of claim 35 wherein the at least one optical subsystem in optical communication with the at least one nonlinear optical generator includes at least one optical component selected from the group consisting of lenses, mirrors, beam directors, sensors, detectors, gratings, prisms, mode scramblers, mode shapers, optical fibers, controllers, processors, attenuators, and computer networks.

38. The homogeneous laser light source of claim 35 wherein the at least one optical subsystem in optical communication with the at least one nonlinear optical generator includes at least one laser line generator device configured to condition the at least one modeless harmonic output signal to produce at least one output signal 32 having a desired irradiance profile.

39. The homogeneous laser light source of claim 35 wherein the at least one laser line generator device comprises at least one Powell lens.

40. The homogeneous laser light source of claim 35 wherein the at least one laser line generator device comprises a two-dimensional aspheric curved optical element having a high spherical aberration configured to redistribute a substantially Gaussian intensity profile of the at least one modeless harmonic output signal to at least one output signal having at least one laser line profile.

41. An optical system for use with a homogeneous laser light system, comprising:
at least one beam director in optical communication with at least one nonlinear optical generator of the homogenous laser light source;
multiple Powell lenses positioned adjacently and in optical communication with the at least one beam director, each Powell lens of the multiple Powell lenses configured to act as an individual laser line generator device wherein at least a portion of each laser line output signal output by each Powell lens overlaps and/or is super-imposed on an adjacent laser line output signal output by an adjacent Powell lens to redistribute a substantially Gaussian intensity profile of at least one harmonic output signal from the at least one nonlinear optical generator incident on the multiple Powell lenses to produce at least one laser line output signal having a substantially uniform intensity in one direction.

42. An optical system for use with a homogeneous laser light system of claim 41 further comprising at least one cylindrical lens configured to condense the intensity of the at least one laser line output signal in at least on direction.

43. A broadband laser light source, comprising
at least one broadband seed source configured to output at least one broadband seed signal;
at least one amplifier in communication and configured to receive the at least one broadband seed signal and output at least one broadband amplifier signal; and at least one nonlinear optical generator in communication with the at least one amplifier, the at least one nonlinear generator configured to generate at least one broadband output signal in response to the at least one broadband amplifier signal, wherein a wavelength of the at least one broadband output signal is different than a wavelength of the at least one broadband amplifier signal.

44. The broadband laser light source of claim 43 wherein the at least one broadband seed source includes at least one low coherence light source therein.

45. The broadband laser light source of claim 44 wherein the at least one low coherence light source comprises at least one fiber seed laser light source.

46. The broadband laser light source of claim 44 wherein the at least one low coherence light source comprises at least one Yb fiber seed laser light source.

47. The broadband laser light source of claim 44 wherein the at least one low coherence light source comprises at least one amplified spontaneous emission light source.

48. The broadband laser light source of claim 44 wherein the at least one broadband seed source includes at least one incoherent light source therein.

49. The broadband laser light source of claim 48 wherein the at least one low coherence light source comprises at least one superluminescent light source.

50. The broadband laser light source of claim 44 wherein the at least one broadband seed source includes at least one semiconductor optical amplifier therein.

51. The broadband laser light source of claim 44 wherein the at least one broadband seed source includes at least one fiber amplifier therein.

52. The broadband laser light source of claim 44 wherein the at least one amplifier includes at least one bulk amplifier.

53. The broadband laser light source of claim 44 wherein the at least one amplifier includes at least one fiber amplifier.

54. The broadband laser light source of claim 53 wherein the at least one amplifier includes at least one large mode area fiber amplifier.

55. The broadband laser light source of claim 53 wherein the at least one amplifier includes at least one single crystal, fiber preamplifier.

56. The broadband laser light source of claim 44 wherein the at least one amplifier includes at least one mode scrambler.

57. The broadband laser light source of claim 56 wherein the at least one amplifier includes at least one fiber mode scrambler.

58. The broadband laser light source of claim 44 wherein the at least one amplifier comprises at least one Neodymium-doped vanadate gain device.

59. The broadband laser light source of claim 44 wherein the at least one amplifier includes at least one Ytterbium doped YAG gain device.

60. The broadband laser light source of claim 44 wherein the at least one amplifier includes at least one Ytterbium doped YALO gain device.

61. The broadband laser light source of claim 44 wherein the at least one amplifier includes at least one Ytterbium doped vanadate gain device.

62. The broadband laser light source of claim 44 wherein the at least one amplifier includes at least one Ytterbium doped CALGO gain device.

63. The broadband laser light source of claim 44 wherein the at least one amplifier includes at least one Ytterbium doped lutetium gain device.

64. The broadband laser light source of claim 44 wherein the at least one amplifier includes at least one Ytterbium doped Calcium Fluoride gain device.

65. The broadband laser light source of claim 44 wherein the at least one amplifier includes at least one multi-mode fiber amplifier gain device.

66. The broadband laser light source of claim 44 wherein the at least one amplifier includes at least one fiber rod amplifier.

67. The broadband laser light source of claim 44 wherein the at least one broadband nonlinear output signal has a wavelength from about 50 nm to about 1500 nm.

68. The broadband laser light source of claim 44 wherein the at least one broadband nonlinear output signal has a wavelength from about 100 nm to about 400 nm.

69. The broadband laser light source of claim 44 wherein the at least one broadband nonlinear output signal has a wavelength from about 300 nm to about 550 nm.

70. The broadband laser light source of claim 44 wherein the at least one nonlinear generator includes at least one optical crystal configured to at least one broadband nonlinear output signal having a wavelength which comprises a harmonic of the at least one broadband amplifier signal.

71. The broadband laser light source of claim 70 wherein the at least one nonlinear generator includes at least one optical crystal configured to provide at least one broadband nonlinear output signal having a wavelength which comprises a second harmonic of the at least one broadband amplifier signal.

72. The broadband laser light source of claim 70 wherein the at least one nonlinear generator includes at least one optical crystal configured to at least one broadband nonlinear output signal having a wavelength which comprises a third harmonic of the at least one broadband amplifier signal.

73. The broadband laser light source of claim 70 wherein the at least one nonlinear generator includes at least one optical crystal configured to at least one broadband nonlinear output signal having a wavelength which comprises a fourth harmonic of the at least one broadband amplifier signal.

74. The broadband laser light source of claim 44 further comprising at least one optical subsystem in optical communication with the at least one nonlinear generator.

75. The broadband laser light source of claim 74 wherein the at least one optical subsystem in optical communication with the at least one nonlinear generator comprises one or more combiner systems configured to combine multiple wavelengths of the at least one broadband nonlinear output signal.

76. The broadband laser light source of claim 74 wherein the at least one optical subsystem in optical communication with the at least one nonlinear generator includes at least one optical component selected from the group consisting of lenses, mirrors, beam directors, sensors, detectors, gratings, prisms, mode scramblers, mode shapers, optical fibers, controllers, processors, attenuators, diffractive optical elements, refractive optical elements, lens arrays, aspherical lenses, and Powell lens.

77. The broadband laser light source of claim 74 wherein the at least one optical subsystem in optical communication with the at least one nonlinear generator includes at least one laser line generator device configured to condition the at least one broadband nonlinear output signal to produce at least one output signal having a desired irradiance profile.

78. The broadband laser light source of claim 77 wherein the at least one laser line generator device comprises an optical element configured to redistribute a substantially Gaussian intensity profile of the at least one broadband nonlinear output signal to at least one output signal having at least one laser line profile in at least one cross-sectional dimension.
